(19) United States
(12) Patent Application Publication
(10) Pub. No.: US 2017/0300971 A1
(43) Pub. Date: Oct. 19, 2017

(54) Information Processing System, Information Processing Apparatus, and Information Processing Method

(71) Applicant: Cloudian Holdings Inc., Dover, DE (US)

(72) Inventors: Hiroshi OHTA, Tokyo (JP); Takenori SATO, Tokyo (JP)

(21) Appl. No.: 15/244,902

(22) Filed: Aug. 23, 2016

(30) Foreign Application Priority Data
Apr. 15, 2016 (JP) 2016082219

(51) Int. Cl. G06Q 30/02; G06K 9/00; G06K 9/62

(52) U.S. Cl. CPC G06Q 30/0261; G06K 9/6256; G06K 9/00785; G06K 2209/15

(57) ABSTRACT

PROBLEM

Provided are an information processing system, an information processing apparatus, and an information processing method those for generating statistical data of vehicles traveling at a predetermined location.

MEANS FOR SOLVING THE PROBLEM

An information processing system 100 according to one embodiment of the disclosure herein includes an imaging unit 131 for capturing an image of a vehicle which is traveling, and a controller 121 for identifying a model of the vehicle based on the image of the vehicle captured by the imaging unit 131 and generating statistical data based on the model thus identified.

### TECHNICAL FIELD

This disclosure relates to an information processing system, an information processing apparatus, and an information processing method those for generating statistical data of vehicles traveling at a predetermined location.

### BACKGROUND

There has conventionally been known outdoor advertisements displayed for a driver of a vehicle or the like. For example, PLT 1 discloses a system for displaying, in an outdoor billboard, advertisements which vary depending on the time of day, a traffic amount, and the like.

### CITATION LIST

### Patent Literature

PLT 1: JP2007122673A

### SUMMARY

However, the system disclosed in the PLT 1 displays the advertisements based on a pre-surveyed traffic amount in contrast to attributes of vehicles traveling at that moment. Therefore, this system does not necessarily display advertisements that matches the attributes of the vehicles traveling at that moment. Further, since this system cannot know the attributes of the vehicles traveling at a location where the driver may view the advertisements, it is difficult to evaluate the effectiveness of the advertisements.

In view of the above problem, it could be helpful to provide an information processing system, an information processing apparatus, and an information processing method those for generating statistical data of vehicles traveling at a predetermined location.

In order to solve the above problem, an information processing system according to one embodiment of the disclosure herein includes:

an imaging unit for capturing an image of a vehicle which is traveling; and

a controller for identifying a model of the vehicle based on the image of the vehicle captured by the imaging unit and generating statistical data based on the model.

The information processing system further includes a display unit for displaying information, wherein

the controller may display information corresponding to the statistical data in the display unit.

In the information system, the display unit is a digital signage, and the information displayed in the digital signage by the controller may be advertisements.

The information processing system further includes a second imaging unit for capturing an image of a portion of the vehicle having information about the model written therein, wherein

the controller, when an identified model does not match the model of the vehicle which is read from the image captured by the second imaging unit, may update a program for identifying the model of the vehicle based on the image of the vehicle and the model of the vehicle which is read.

In the information processing system, also, the controller may identify the model of the vehicle based on deep learning.

It is to be understood that an information processing apparatus and an information processing method those correspond to the information processing system described above may substantialize the disclosure herein and thus are included in the scope of the disclosure herein.

For example, an information processing apparatus according to one embodiment of the disclosure herein includes a controller for identifying a model of a vehicle based on an image of the vehicle which is traveling, and generating statistical data for each model.

Also, an information processing method according to one embodiment of the disclosure herein is an information processing method performed by an information processing system including an imaging unit for capturing an image and a controller, the information processing method includes:

a capturing step in which the imaging unit captures an image of a vehicle which is traveling;

an identifying step in which the controller identifies a model of the vehicle based on the image captured at the capturing step; and

a generating step in which the controller generates statistical data for each model identified at the identifying step.

The information processing system, the information processing apparatus, and the information processing method those configured as described above may generate statistical data of vehicles traveling at a predetermined location.

### BRIEF DESCRIPTION OF THE DRAWINGS

In the accompanying drawings:

FIG. 1 is a functional block diagram illustrating a schematic configuration of an information processing system according to one embodiment of the disclosure herein;

FIG. 2 is a schematic diagram illustrating an example of the use of the information processing system in FIG. 1;

FIGS. 3A and 3B are diagrams illustrating an example of a method to extract ranges capturing vehicles by a second information processing apparatus in FIG. 1;

FIG. 4 is a sequence diagram illustrating an example of an operation for displaying information performed by the information processing system in FIG. 1;

FIG. 5 is a sequence diagram illustrating a summary of an update operation of a model determination program performed by the information processing system in FIG. 1; and

FIG. 6 is a flowchart illustrating an example of an update operation of the model determination program performed by a first information processing apparatus in FIG. 1.

### DETAILED DESCRIPTION

Hereinafter, one embodiment of the disclosure herein will be described in detail with reference to the accompanying drawings.

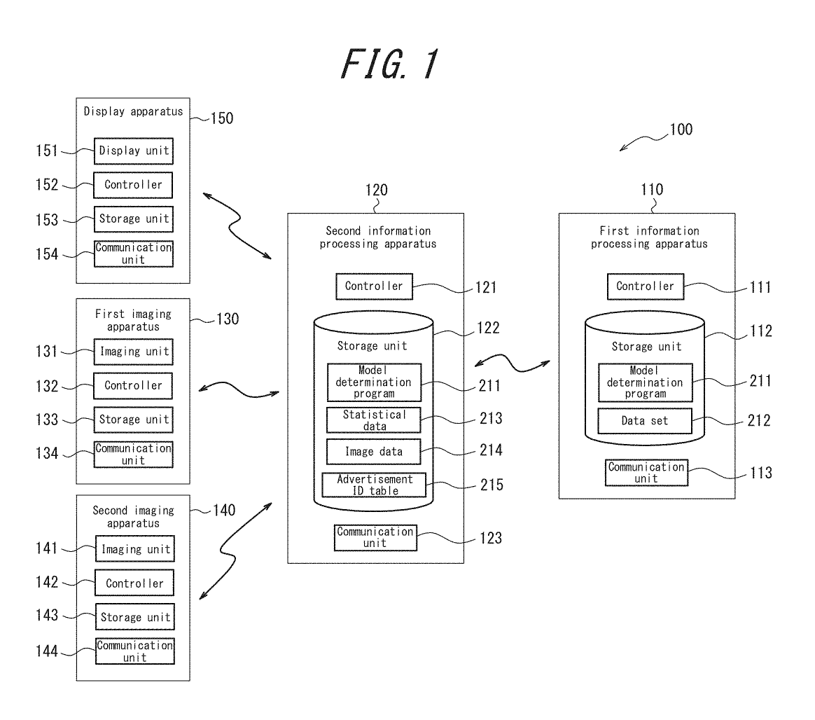

FIG. 1 is a functional block diagram illustrating a schematic configuration of an information processing system 100 according to one embodiment of the disclosure herein. As illustrated in FIG. 1, the information processing system 100 according to the present embodiment includes a first information processing apparatus 110, a second information processing apparatus 120, a first imaging apparatus 130, a second imaging apparatus 140, and a display apparatus 150. The second information processing apparatus 120 is configured to be able to communicate with the first information processing apparatus 110, the first imaging apparatus 130, the second imaging apparatus 140, and the display apparatus 150. Each of these apparatuses may be configured to be able to communicate with one another via the Internet or the like, as necessary.

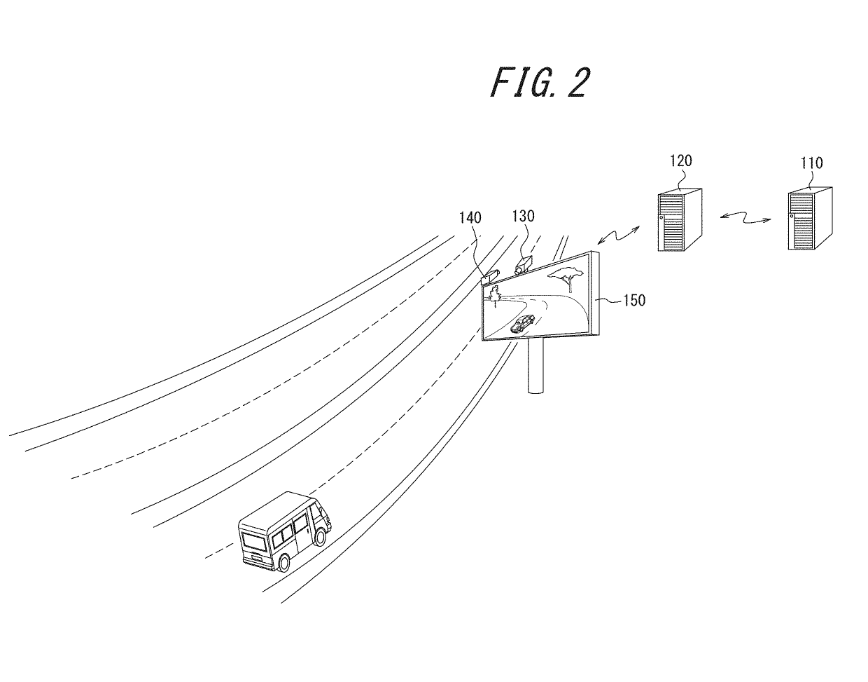

FIG. 2 is a schematic diagram illustrating an example of the use of the information processing system 100 in FIG. 1. The display apparatus 150 displays various information. According to the present embodiment, the display apparatus 150, as illustrated in FIG. 2, for example, is a digital signage (an electronic billboard) placed at a location where a driver of a vehicle travelling on the road can view. The display apparatus 150 is placed, for example, on a wall of a building, on the roadside, and the like. The display apparatus 150 displays predetermined information based on a control signal acquired from the second information processing apparatus 120. According to the present embodiment, the display apparatus 150 displays various advertisements directed to the driver.

The first imaging apparatus 130 captures an image of a vehicle traveling at a location where the driver may view the advertisement displayed in the display apparatus 150, or a location where the driver may view the advertisement after a predetermined period of time. The first imaging apparatus 130 is a fixed point camera for capturing, for example, a predetermined position on the road. The first imaging apparatus 130 captures an image of a vehicle traveling on the road. The first imaging apparatus 130 captures, for example, an image of a front side, i.e., a traveling direction of a vehicle traveling in front of the display apparatus 150.

The second imaging apparatus 140 captures an image of a rear side of the vehicle captured by the first imaging apparatus 130. Similarly to the first imaging apparatus 130, the second imaging apparatus 140 is the fixed point camera for capturing, for example, the predetermined position on the road. The second imaging apparatus 140 captures the road after the vehicle has passed the location where the driver may view the display apparatus 150 and thereby captures the rear side of the vehicle. The second imaging apparatus 140 may capture the image of the rear side of the vehicle by capturing, from a different angle, the position on the road the same as that captured by the first imaging apparatus 130. The images captured by the first imaging apparatus 130 and the second imaging apparatus 140 are transmitted to the second information processing apparatus 120. Note that, as described later, the second imaging apparatus 140 captures the image to be used for an update operation of a model determination program 211 used by the information processing system 100 and not essential for the generation of statistical data 213.

The second information processing apparatus 120 determines advertisements to be displayed in the display apparatus 150 based on the image captured by the first imaging apparatus 130 and transmits a control signal to display the advertisements thus determined to the display apparatus 150. That is, in the information processing system 100, predetermined advertisements displayed in the display apparatus 150 are determined and controlled by the second information processing apparatus 120 based on the image captured by the first imaging apparatus 130. In particular, the second information processing apparatus 120 determines a model of the vehicle (a vehicle name, a model, year, a type, and the like) based on the image captured by the first imaging apparatus 130 and generates the statistical data 213 associated with the model of the vehicle based on the model thus determined. For the determination on the model of the vehicle, deep learning is used. The second information processing apparatus 120 controls the display apparatus 150 to display the advertisements corresponding to the statistical data 213 thus generated.

A program (the model determination program 211) used by the second information processing apparatus 120 to determine the model of the vehicle is generated by the first information processing apparatus 110. Also, the first information processing apparatus 110 performs learning on the basis of the image captured by the first imaging apparatus 130 and the second imaging apparatus 140 acquired via the second information processing apparatus 120 and updates the model determination program 211. The first imaging apparatus 130 transmits the model determination program 211 thus updated to the second imaging apparatus 140, and the second imaging apparatus 140, by using the model determination program 211, controls such that the advertisements to be displayed in the display apparatus 150 is determined.

Returning back to FIG. 1, each constituent of the information processing system 100 will be described in detail.

The first information processing apparatus 110 is constituted by using, for example, a server apparatus. The first information processing apparatus 110 includes a controller 111, a storage unit 112, and a communication unit 113.

The controller 111 is a processor for controlling and managing the first information processing apparatus 110 in its entirety including each functional block thereof. The controller 111 is constituted by using a processor such as CPU (Central Processing Unit) and the like for executing a program which defines control procedure. The program executed by the processor is stored in, for example, the storage unit 112 or an external storage medium.

The controller 111 generates the model determination program 211 used for the determination on the model of the vehicle. According to the present embodiment, the controller 111, by using the deep learning, generates the model determination program 211. The deep learning is a technique to automatically calculate and learn a feature quantity of data by using a neural network having a multilayer structure. The controller 111 performs the deep learning by using, for example, a data set 212 stored in the storage unit 112. The controller 111 may perform the deep learning by using a data set (corresponding data of the image and the model and the like) acquired from the outside of the first information processing apparatus 110.

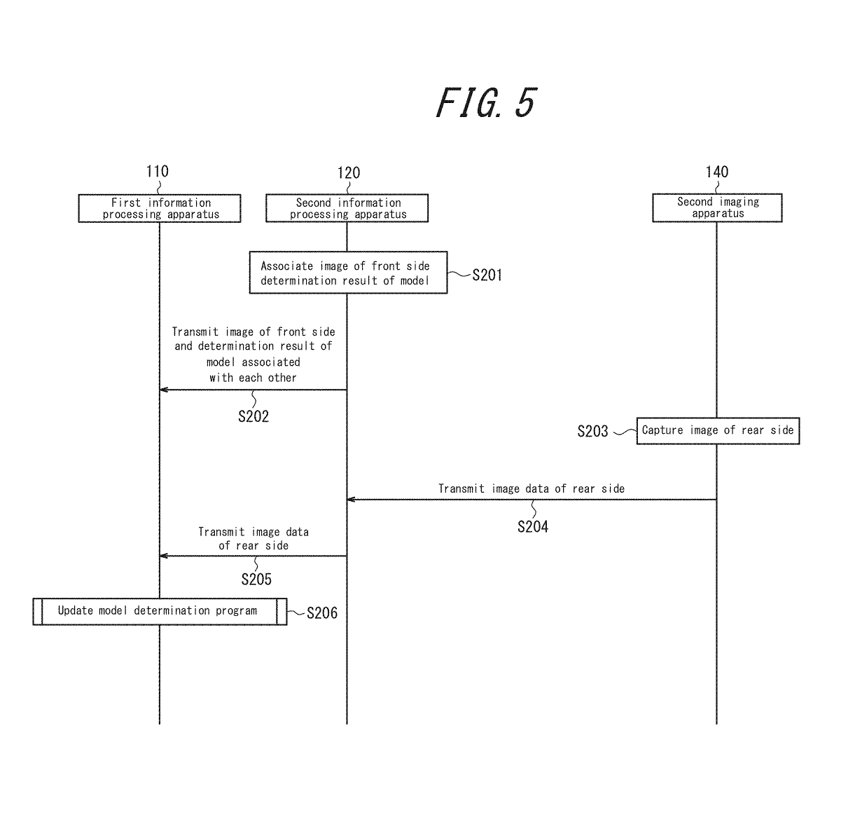

Also, the controller 111 updates the model determination program 211 based on the images captured by the first imaging apparatus 130 and the second imaging apparatus 140 acquired via the second information processing apparatus 120. The update of the model determination program 211 will be described in detail later with reference to FIG. 5.

The storage unit 112 includes various memory devices and, depending on the application, stores various information such as, for example, data essential for an operation of the controller 111. The storage unit 112 also includes a device such as RAM (Random Access Memory) or the like which functions as a work memory. The storage unit 112 stores the model determination program 211 and the data set 212. The model determination program 211 is a program generated by the controller 111 by performing the deep learning. The data set 212 is a series of data used by the controller 111 to generate the model determination program 211. The data set 212 may be, for example, input by an administrator of the first information processing apparatus 110, or acquired by the first information processing apparatus 110 from an external source. The data set 212 may additionally include actual video data. The data set 212 includes, for example, a combination of the image of the vehicle and information about the vehicle. The information about the vehicle is information about the model of the vehicle including, for example, the vehicle name, the model, the year, the type, and the like. The information about the vehicle is not limited thereto but may include other information about the vehicle.

The communication unit 113 performs a wired communication or a radio communication with the second information processing apparatus 120 and thus transmits and receives various information. For example, the first information processing apparatus 110, via the communication unit 113, transmits the model determination program 211 generated by the controller 111 to the second information processing apparatus 120. Also, for example, the first information processing apparatus 110, via the communication unit 113, receives data such as the images captured by the first imaging apparatus 130 and the second imaging apparatus 140 held by the second information processing apparatus 120.

The second information processing apparatus 120 is constituted by using, for example, the server apparatus. The second information processing apparatus 120 includes a controller 121, a storage unit 122, and a communication unit 123.

The controller 121 is a processor for controlling and managing the second information processing apparatus 120 in its entirety including each functional block thereof. The controller 121 is constituted by using the processor such as the CPU and the like for executing the program which defines the control procedure. The program executed by the processor is stored in, for example, the storage unit 122 or an external storage medium.

The controller 121, based on the image capturing the vehicle captured by the first imaging apparatus 130, determines the model of the vehicle captured in the image and generates the statistical data 213 based on a result of the determination. Also, the controller 121, based on the statistical data 213, determines the advertisement to be displayed in the display apparatus 150.

The controller 121, first, extracts (identifies) a range in which the vehicle is captured in the image captured by the first imaging apparatus 130. The range may be extracted by employing any method.

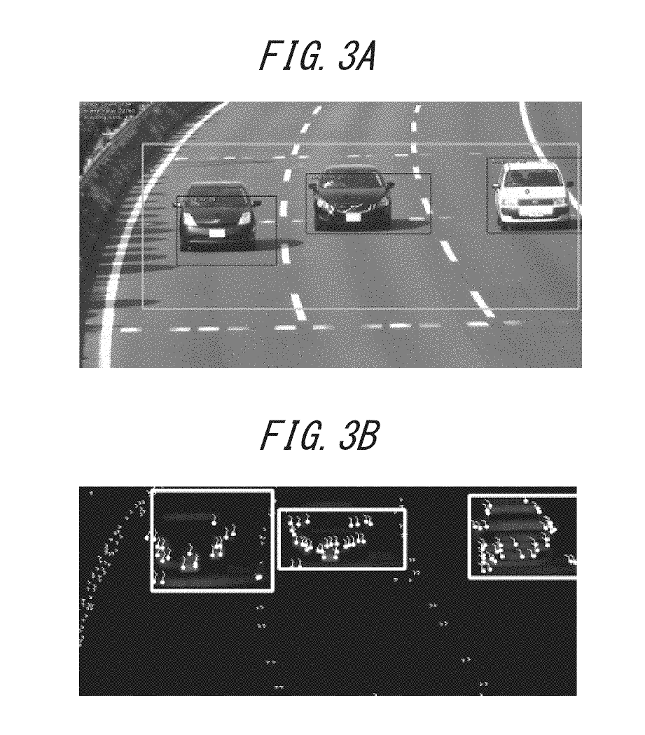

FIG. 3 are diagrams illustrating an example of an extraction method of the range employed by the second information processing apparatus 120. FIG. 3A illustrates an example of an image captured by the first imaging apparatus 130, and FIG. 3B illustrates an example of an image demonstrating processing procedure performed on the image of FIG. 3A by the second information processing apparatus 120. In one example of the extraction method of the range, the controller 121 employs an optical flow method, and tracks and records features (characteristic points) of the vehicle over a plurality of successive frames of the images captured by the first imaging apparatus 130. The features tracked by the controller 121 are represented by lines extending vertically (in a travel direction of the vehicle) in FIG. 3B. By employing the optical flow method, the controller 121 detects a movement of the vehicle in the image. Then, the controller 121, by employing a background subtraction method, calculates a weighted average of the images in the plurality of successive frames from the images captured by the first imaging apparatus 130 and calculates a difference between a result of the above calculation and the image of the frame lastly obtained. Thereby, the controller 121 detects a substance moving in the image, i.e., the vehicle. The controller 121, by employing the optical flow method and the background subtraction method, extracts the range in which the vehicle is captured from the image captured by the first imaging apparatus 130. Each extracted range is represented by an area surrounded by a square in FIG. 3B. The methods employed by the controller 121 are not limited to the above methods; the controller 121 may employ other methods to extract the range in which the vehicle is captured.

The controller 121, after extracting the range in which the vehicle is captured, based on the image of the vehicle in the extracted range, uses the model determination program 211 and determines the model of the vehicle.

Then, the controller 121, based on the model thus determined, generates the statistical data 213 associated with the model of the vehicle. The statistical data 213 are statistical data associated with the model of the vehicle travelling at the predetermined location on the road captured by the first imaging apparatus 130. The statistical data 213 includes, for example, data associated with the model of the vehicle for each predetermined period of time. Setting the predetermined period of time to several seconds or less, the controller 121 may know, on a real time basis, the model of the vehicle traveling at the predetermined location. The controller 121, by referring to the statistical data 213, may acquire the model of the vehicle traveling at the predetermined location in each predetermined period of time. From the statistical data 213, the controller 121 may also acquire, for example, a tendency in a change of the models of the vehicles with time.

The controller 121, based on the statistical data 213, determines the advertisement (information) to be displayed in the display apparatus 150. At this time, the controller 121 determines the advertisement to be displayed in the display apparatus 150 based on the statistical data 213 associated with the model of the vehicle traveling at the predetermined location on the real time basis. The controller 121, for example, determines an advertisement ID of the advertisement corresponding to the determined model. The advertisement ID is information uniquely corresponds to each advertisement which may be displayed in the display apparatus 150. The controller 121, by referring to a table (an advertisement ID table 215) which allows the determination on the advertisement ID based on the contents of the statistical data 213, determines the advertisement ID based on the contents of the statistical data 213. For example, the controller 121, based on the highest number of models in the statistical data 213, refers to the advertisement ID table 215 and determines the advertisement ID. Alternatively, the controller 121, for example, based on a ratio of each model in the statistical data 213, may refer the advertisement ID table 215 and determine the advertisement ID. The advertisement associated with the advertisement ID is, for example, an advertisement directed to a purchaser or an owner of the vehicle of the model associated with the advertisement ID. Such an advertisement is, for example, an advertisement about products of the same manufacturer of the vehicle of the model associated with the advertisement ID, an advertisement about products that is highly likely purchased by a group of the purchasers of the vehicle of the model associated with the advertisement ID, and the like. The controller 121 transmits, as the control signal, the advertisement ID and an order to display the advertisement corresponding to the advertisement ID to the display apparatus 150, and thus controls the display apparatus 150 to display the advertisement determined.

The storage unit 122 may include various memory devices and, depending on the application, stores various information such as, for example, data essential for an operation of the controller 121. The storage unit 122 also includes a device such as the RAM or the like which functions as the work memory. The storage unit 122 stores the model determination program 211, the statistical data 213, image data 214, and the advertisement ID table 215. The model determination program 211 is acquired from the first information processing apparatus 110 by the second information processing apparatus 120 and stored in the storage unit 122. The model determination program 211 is appropriately updated by the first information processing apparatus 110. The image data 214 are data associated with the images captured by the first imaging apparatus 130 and the second imaging apparatus 140 acquired therefrom by the second information processing apparatus 120. The image data 214 are transmitted to, for example, the first information processing apparatus 110 and used by the first information processing apparatus 110 to update the model determination program 211.

The communication unit 123 performs the wired communication or the radio communication with the first information processing apparatus 110, the first imaging apparatus 130, the second imaging apparatus 140, and the display apparatus 150 and thus transmits and receives various information. For example, the second information processing apparatus 120, via the communication unit 123, acquires the model determination program 211 from the first information processing apparatus 110. Also, for example, the second information processing apparatus 120, via the communication unit 123, acquires the images captured by the first imaging apparatus 130 and the second imaging apparatus 140 from the first imaging apparatus 130 and the second imaging apparatus 140. Also, the second information processing apparatus 120, via the communication unit 123, transmits the images captured by the first imaging apparatus 130 and the second imaging apparatus 140 to the first information processing apparatus 110. Further, for example, the second information processing apparatus 120, via the communication unit 123, transmits the control signal to the display apparatus 150. The second information processing apparatus 120 acquires the image from the first imaging apparatus 130 on the real time basis, generates the control signal based on the image thus acquired, and then transmits the control signal to the display apparatus 150.

The first imaging apparatus 130 includes an imaging unit 131, a controller 132, a storage unit 133, and a communication unit 134.

The imaging unit 131 captures the image of the vehicle traveling on the road. The imaging unit 131 is constituted by using, for example, a digital video camera.

The controller 132 is a processor for controlling and managing the first imaging apparatus 130 in its entirety including each functional block thereof. The controller 132 is constituted by using the processor such as the CPU and the like for executing the program which defines the control procedure. The program executed by the processor is stored in, for example, the storage unit 133 or an external storage medium.

The storage unit 133 includes various memory devices and, depending on the application, stores various information such as, for example, data and the like essential for an operation of the controller 132. The storage unit 133 also includes a device such as the RAM or the like which functions as the work memory. The storage unit 133 may store, for example, the image data 214 of the image captured by the imaging unit 131.

The communication unit 134 performs the wired communication or the radio communication with the second information processing apparatus 120 and thus transmits and receives various information. For example, the first imaging apparatus 130, via the communication unit 134, transmits the image data 214 of the image captured by the imaging unit 131 to the second information processing apparatus 120.

The second imaging apparatus 140 includes an imaging unit 141, a controller 142, a storage unit 143, and a communication unit 144. A function of each of the imaging unit 141, the controller 142, the storage unit 143, and the communication unit 144 in the second imaging apparatus 140 is similar to the function of each of the imaging unit 131, the controller 132, the storage unit 133, and the communication unit 134 in the first imaging apparatus 130, respectively, and thus detailed descriptions thereof will be omitted here.

The display apparatus 150 includes a display unit 151, a controller 152, a storage unit 153, and a communication unit 154.

The display unit 151 is a display device constituted by using a known display such as an LED (Light Emitting Diode) display, a liquid crystal display (LCD), an organic electroluminescence display (OELD), or the like. The display unit 151 displays the advertisement under the control of the controller 152.

The controller 152 is a processor for controlling and managing the display apparatus 150 in its entirety including each functional block thereof. The controller 152 is constituted by using the processor such as the CPU and the like for executing the program which defines the control procedure. The program executed by the processor is stored in, for example, the storage unit 153 or an external storage medium. The controller 152, based on the control signal acquired from the second information processing apparatus 120, displays various advertisements in the display unit 151.

The storage unit 153 includes various memory devices and, depending on the application, stores various information such as, for example, data and the like essential for an operation of the controller 132. The storage unit 153 also includes a device such as the RAM or the like which functions as the work memory. The storage unit 153 stores, for example, the advertisement to be displayed in the display unit 151 as an image or a video. The storage unit 153 stores each advertisement in association with the advertisement ID.

The communication unit 154 performs the wired communication or the radio communication with the second information processing apparatus 120 and thus transmits and receives various information. For example, the display apparatus 150, via the communication unit 154, acquires the control signal from the second information processing apparatus 120 and, based on the control signal thus acquired, displays the information in the display unit 151.

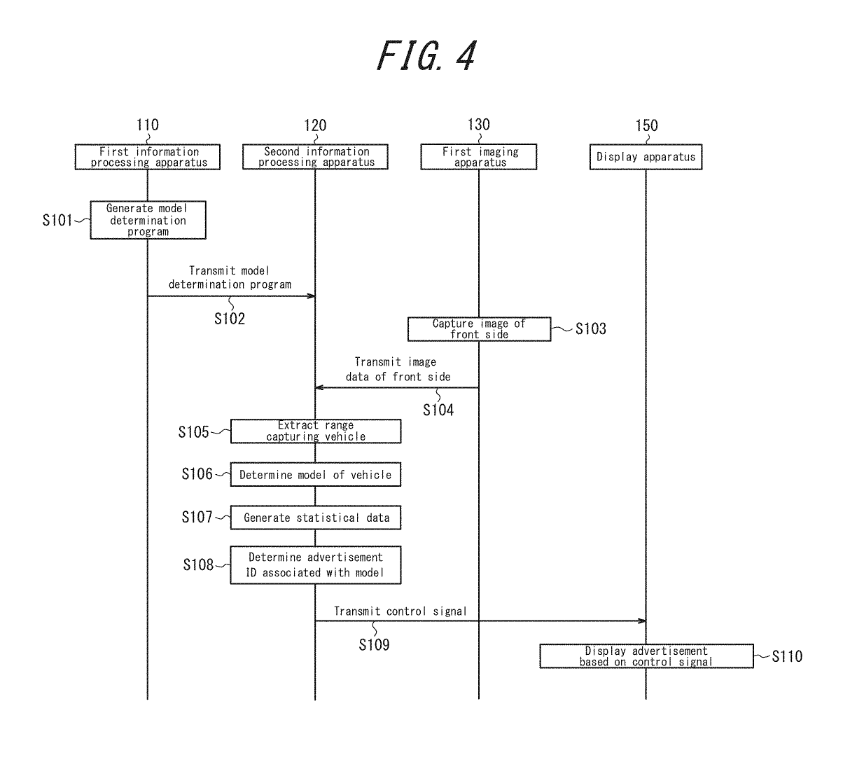

Next, an example of an operation for displaying the information by the information processing system 100 will be described with reference to FIG. 4.

First, the first information processing apparatus 110, based on the data set, performs the deep learning and generates the model determination program 211 (step S101).

The first information processing apparatus 110 transmits the model determination program 211 generated at step S101 to the second information processing apparatus 120 (step S102).

Next, the first imaging apparatus 130 captures the image (step S103). The image captured by the first imaging apparatus 130 is the image of the front side of the vehicle.

The first imaging apparatus 130 transmits the image data 214 associated with the image captured by the step S103 to the second information processing apparatus 120 (step S104). The first imaging apparatus 130 may repeat the steps S103 and S104 at all times, or on a regular basis.

The second information processing apparatus 120, upon reception of the image data 214 from the first imaging apparatus 130, extracts the range capturing the vehicle from the image in the image data 214 (step S105).

Subsequently, the second information processing apparatus 120, based on the image of the vehicle captured in the extracted range, determines the model of the vehicle by using the model determination program 211 (step S106).

Then, the second information processing apparatus 120, based on the model of the vehicle thus determined, generates the statistical data 213 (step S107).

The second information processing apparatus 120 refers to the advertisement ID table 215 stored in the storage unit 122 and, based on the statistical data 213 generated at step S107, determines the advertisement ID of the advertisement to be displayed in the display apparatus 150 (step S108).

The second information processing apparatus 120 transmits the control signal containing the advertisement ID determined at step S108 to the display apparatus 150 (step S109).

The display apparatus 150, upon reception of the control signal, based on the control signal, displays the advertisement associated with the advertisement ID in the display unit 151 (step S110).

According to the information processing system 100 of the present embodiment, as described above, the second information processing apparatus 120 determines, on the real time basis, the model of the vehicle traveling at the location where the driver may view the advertisement displayed in the display apparatus 150, and generates the statistical data 213 based on the model determined. Then, the second information processing apparatus 120, based on the statistical data 213, may display the advertisement directed to the purchaser or the owner of the vehicle of the determined model in the display apparatus 150. Therefore, the information processing system 100 may display the advertisement based on the viewer of the advertisement and facilitates the display of the advertisements that suits views' needs.

According to the information processing system 100 of the present embodiment, also, the statistical data 213 enables an analysis of the models of the vehicles traveling at the location where the driver may view the display apparatus 150 when the advertisement is displayed in the display apparatus 150. Therefore, the information processing system 100 provides information about the attribute of the viewer who views the advertisement displayed in the display apparatus 150, facilitating an evaluation of the advertisement.

According to the information processing system 100 of the present embodiment, further, the model of the vehicle is determined based on the program generated by using the deep learning. Therefore, as compared with the determination without using the deep learning, an accuracy in the determination on the model of the vehicle is improved.

Next, an example of an update operation of the model determination program 211 performed by the information processing system 100 will be described with reference to FIG. 5.

In the update operation of the model determination program 211, the second information processing apparatus 120 associates the image of the front side acquired from the first imaging apparatus 130 with the model of the vehicle determined at step S106 in FIG. 4 (step S201).

The second information processing apparatus 120 transmits the image of the front side associated at step S201 (the image data 214) and the result of the determination on the model to the first information processing apparatus 110 (step S202).

Next, the second imaging apparatus 140 captures the image (step S203). The image captured by the second imaging apparatus 140 is the image of the rear side of the vehicle.

The second imaging apparatus 140 transmits the image data 214 associated with the image captured at step S203 to the second information processing apparatus 120 (step S204). The second imaging apparatus 140 may repeat the steps S203 and S204 at all times, or on a regular basis.

The second information processing apparatus 120 transmits the image data 214 received from the second imaging apparatus 140 to the first information processing apparatus 110 (step S205).

Then, the first information processing apparatus 110 executes the update operation of the model determination program 211 (step S206).

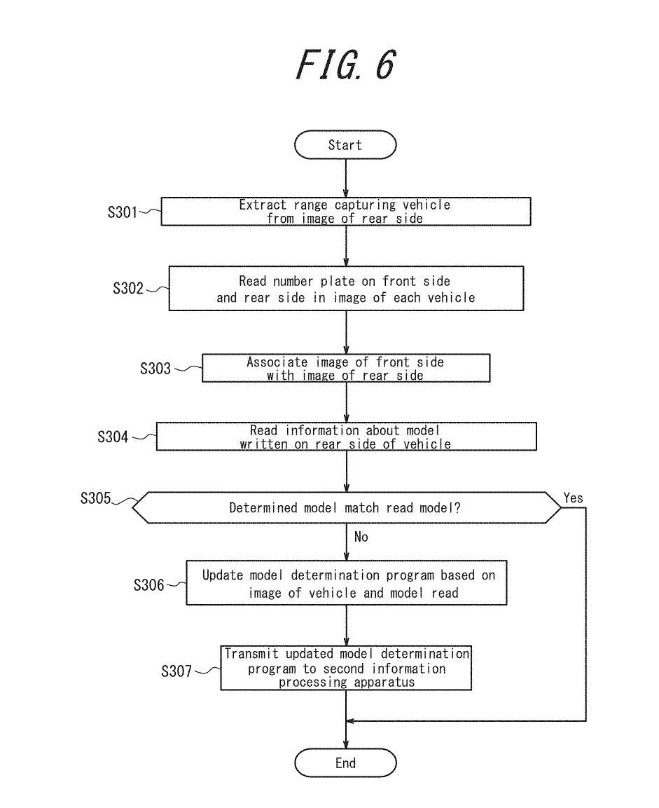

FIG. 6 is a flowchart illustrating an example of the update operation of the model determination program 211 performed by the first information processing apparatus 110.

The first information processing apparatus 110, from each image of the rear side of the vehicle, extracts the range capturing the vehicle (step S301). For the extraction, the first information processing apparatus 110 may perform any image processing. For example, an extraction method performed by the first information processing apparatus 110 may be similar to the extraction method of the range capturing the vehicle from the image of the front side performed by the second information processing apparatus 120.

Next, the first information processing apparatus 110, from the image of the front side and the image of the rear side of the vehicle subjected to the extraction, reads a number plate attached to the front side and the rear side of each vehicle (step S302). Here, the number plate is a plate having a vehicle registration number written thereon and includes an automobile registration number certificate and a vehicle number certificate. The first information processing apparatus 110, by using, for example, a known method, may identify a position of the number plate of the vehicle and read a character and a number (hereinafter, abbreviated as a “number”) written on the number plate.

Next, the first information processing apparatus 110 associates the number of the number plate that has been read with the image having a matching number on the front side and the rear side of the vehicle, thereby associating the images of the same vehicle with one another (step S303).

Then, the first information processing apparatus 110 analyzes the image and, from the image of the rear side of the vehicle, reads information about the model of the vehicle written on the rear side of the vehicle (step S304). Since it is often the case that the vehicles have the information about the model such as the vehicle name and the type on the rear side thereof, the first information processing apparatus 110 reads the information about the model of the vehicle written on the rear side of the vehicle.

The first information processing apparatus 110 determines whether the model of the vehicle determined by the second information processing apparatus 120 matches the model of the vehicle read at step S304 (step S305).

When the model of the vehicle determined by the second information processing apparatus 120 matches the model of the vehicle read at step S304 (Yes at step S305), the first information processing apparatus 110 ends this flow.

On the other hand, when the first information processing apparatus 110 determines that the model of the vehicle determined by the second information processing apparatus 120 does not match the model of the vehicle read at step S304 (No at step S305), the first information processing apparatus 110 determines that the second information processing apparatus 120 incorrectly determines the model of the vehicle, performs relearning, and then updates the model determination program 211 (step S306). In particular, the first information processing apparatus 110 determines that the model of the vehicle is read correctly, associates the image of the vehicle with the model that is read (the vehicle name, the model, the year, and the type), and updates the model determination program 211 by performing what is called tuning, i.e., making fine adjustments during the deep learning. An updated program is stored in the storage unit 112.

Then, the first information processing apparatus 110 transmits the model determination program 211 which is updated to the second information processing apparatus 120 (step S307). The second information processing apparatus 120, after receiving the model determination program 211 which is updated, determines the model of the vehicle by using the model determination program 211 which is updated, and executes the operation to display the advertisement.

As described above, the information processing system 100 of the present embodiment may capture the front side and the rear side of the vehicle and, based on the captured images, examine whether a result of the determination on the model is correct. When the result of the determination on the model is incorrect, the first information processing apparatus 110 may update the model determination program 211. Since the second information processing apparatus 120 executes the operation to determine the model by using the model determination program 211 which is updated, the accuracy in determination on the model is improved each time the model determination program 211 is updated.

Although the disclosure herein has been described based on the figures and the embodiment, it is to be understood that various changes and modifications may be implemented based on the disclosure by those who are ordinarily skilled in the art. Accordingly, such changes and modifications are included in the scope of the disclosure.

For example, each function and the like included in each constituent, step and the like may be rearranged without logical inconsistency, so as to combine a plurality of constituents or steps together or to separate them.

In particular, for example, although in the above embodiment the information processing system 100 includes the first information processing apparatus 110 and the second information processing apparatus 120 which are independent of each other, the information processing system 100 may include, for example, one information processing apparatus that has functions of both the first information processing apparatus 110 and the second information processing apparatus 120. Also, for example, some or all functions of the second information processing apparatus 120 may be comprehended in at least any one of the first imaging apparatus 130, the second imaging apparatus 140, and the display apparatus 150.

Further, although in the above embodiment the information processing system 100 displays the information such as the advertisement and the like in the display apparatus 150 based on the statistical data 213, the information processing system 100 does not necessarily need to display the information. The information processing system 100 may use the statistical data 213 for another purpose. For example, the statistical data 213 may be used for a traffic analysis at a predetermined location. Using the statistical data 213 for the traffic analysis allows an investigation on a traffic amount of the vehicle of each model. Other than that, the statistical data 213 may be used for any purpose usable the information about each model of the vehicle traveling at the predetermined location.

### EXPLANATION OF REFERENCES

100 information processing system
110 first information processing apparatus
111, 121, 132, 142, 152 controller
112, 122, 133, 143, 153 storage unit
113, 123, 134, 144, 154 communication unit
120 second information processing apparatus
130 first imaging apparatus
131, 141 imaging unit
140 second imaging apparatus
150 display apparatus
151 display unit
211 model determination program
212 data set
213 statistical data
214 image data
215 advertisement ID table

1. An information processing system comprising:
an imaging unit for capturing an image of a vehicle which is traveling; and
a controller for identifying a model of the vehicle based on the image of the vehicle captured by the imaging unit and generating statistical data based on the identified model.

2. The information processing system according to claim 1, further comprising a display unit for displaying information, wherein
the controller displays information corresponding to the statistical data in the display unit.

3. The information processing system according to claim 2, wherein
the display unit is a digital signage, and
the information displayed in the digital signage by the controller is advertisements.

4. The information processing system according to any one of claims 1 to 3, further comprising a second imaging unit for capturing an image of a portion of the vehicle having information about the model written therein, wherein
the controller, when an identified model does not match the model of the vehicle which is read from the image captured by the second imaging unit, updates a program for identifying the model of the vehicle based on the image of the vehicle and the model of the vehicle which is read.

5. The information processing system according to any one of claims 1 to 4, wherein the controller identifies the model of the vehicle based on deep learning.

6. An information processing apparatus comprising a controller for identifying a model of a vehicle based on an image of the vehicle which is traveling, and generating statistical data for each model.

7. An information processing method performed by an information processing system including an imaging unit for capturing an image and a controller, the information processing method comprising:
a capturing step in which the imaging unit captures an image of a vehicle which is traveling;
an identifying step in which the controller identifies a model of the vehicle based on the image captured at the capturing step; and
a generating step in which the controller generates statistical data for each model identified at the identifying step.
